(19) United States
(12) Patent Application Publication
(10) Pub. No.: US 2021/0197476 A1
(43) Pub. Date: Jul. 1, 2021

(54) BUILD MATERIAL RECLAIM IN ADDITIVE MANUFACTURING

(71) Applicant: HEWLETT-PACKARD DEVELOPMENT COMPANY, L.P., Houston, TX (US)

(72) Inventor: Brent EWALD, Vancouver, WA (US)

(73) Assignee: HEWLETT-PACKARD DEVELOPMENT COMPANY, L.P., Houston, TX (US)

(21) Appl. No.: 16/075,015

(22) PCT Filed: Apr. 21, 2017
(86) PCT No.: PCT/US2017/028805

§ 371 Date: Aug. 2, 2018

(51) Int. Cl. B29C 64/357; B29C 64/153; B22F 10/28; B22F 10/73; B33Y 40/00; B33Y 10/00; B33Y 30/00

(52) U.S. Cl. CPC B29C 64/357; B29C 64/153; B22F 10/28; B33Y 30/00; B33Y 40/00; B33Y 10/00; B22F 10/73

(57) ABSTRACT

A three-dimensional (3D) printer and method for feeding powder to a build platform of the 3D printer, Incidental powder lost from the build platform is collected and fed to the build platform.

### BACKGROUND

Additive manufacturing (AM) may include three-dimensional (3D) printing to generate 3D objects. In some AM processes, successive layers of material are formed under computer control to fabricate the object. The material may be powder, or powder-like materials, including metal, plastic, concrete, composite material, and other powders. The objects can be various shapes and geometries, and produced via a model such as a 3D model or other electronic data source. The fabrication may involve laser melting, laser sintering, electron beam melting, fused deposition or fusion, and so on. The model and automated control may facilitate the layered manufacturing and additive fabrication. As for applications, AM may fabricate intermediate and end-use products, as well as prototypes, for aerospace (e.g., aircraft), machine parts, medical devices (e.g., implants), automobile parts, fashion products, structural and conductive metals, ceramics, conductive adhesives, semiconductor devices, and other applications.

### BRIEF DESCRIPTION OF THE DRAWINGS

Certain examples are described in the following detailed description and in reference to the drawings, in which:

FIGS. 1-5 are diagrams of respective 3D printer in accordance with examples;

FIG. 6 is a block flow diagram of a method of operating a 3D printer in accordance with examples;

FIG. 7 is a block flow diagram of another method of operating a 3D in accordance with examples; and

FIG. 8 is a block diagram of an AM system in accordance with examples.

### DETAILED DESCRIPTION OF SPECIFIC EXAMPLES

In AM, a 3D printer may print or form a 3D object from material including powder. After completion of the print job, some powders may be removed from the 3D printer and reused as recycled powder. The recycle powder may be fed to the 3D printer for printing such as for a subsequent print job. Fresh or new powder may be fed to supplement the recycle powder. The new powder may be a significant cost of the 3D printing.

Examples of the present techniques are directed to reclaim of powder in AM 3D printing. For instance, incidental powder lost from a build platform of a 3D printer during printing of a 3D object may be recovered as reclaim powder. The build platform may be associated with a build chamber of the 3D printer. The incidental powder reclaimed may be powder spill-over from the build platform and in the build chamber. The spill-over powder may be collected from the build chamber by vacuum, gravity, or mechanical conveying, and the like.

This incidental powder may be fed back as recovered powder or reclaim powder to the 3D printer during printing of the 3D object. In certain examples, the incidental powder may be collected in a storage vessel (e.g., a hopper) prior to being returned to the 3D printer as feed. In some examples, the incidental powder as reclaim powder may be returned or fed to the 3D printer with other powder feed (e.g., recycle powder, new powder, etc.) to the 3D printer.

In a particular example, the incidental powder is fed to the 3D printer n-line with new and recycle powder feeds during the printing. For instance, respective conduits (e.g., piping, tubing, etc.) within the printer transport each powder, respectively, and may meet or couple, such as via conduit tees or other fitting. Therefore, in this particular example, the new powder, recycle powder, and reclaim powder may be mixed in-line and fed as combined in a conduit to the 3D printer, such as to a feed vessel or build enclosure of the printer.

Moreover, the incidental powder may have the desired or implemented ratio (e.g., weight ratio) of new powder to recycle powder. In sum, the incidental or spill-over powder collected during a print job may be fed back as reclaim powder to the printer during the same print job. In certain examples, the incidental powder or reclaim powder is not classified as 100% recycle powder but instead as feed powder having the desired ratio of new powder to recycle powder.

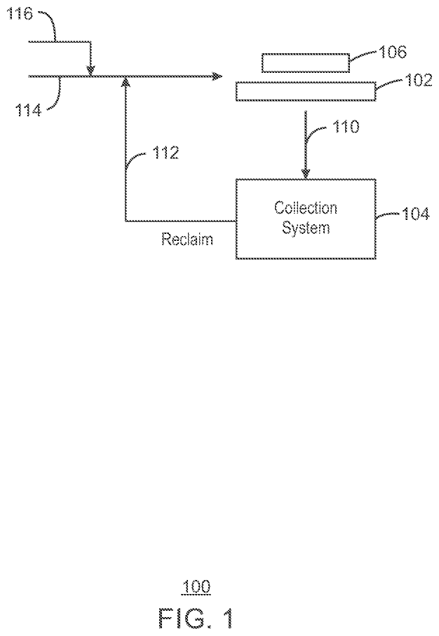

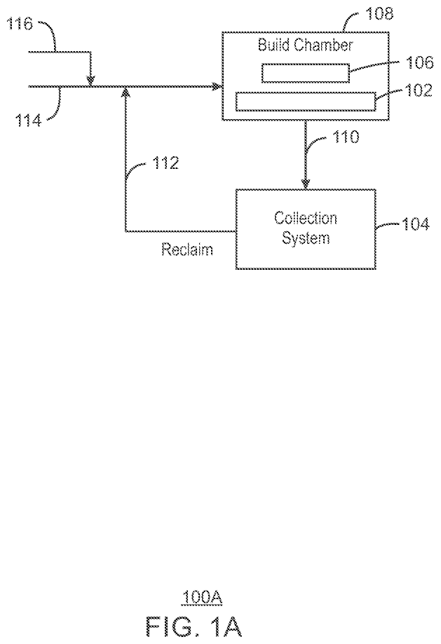

FIGS. 1 and 1A are examples of a 3D printer 100 and 100A, respectively. Referring to FIG. 1 and FIG. 1A together, the 3D printer 100, 100A includes a build platform 102 and a material (e.g., powder) collection system 104. In operation, the 3D printer 100, 100A prints a 3D object 106 from material including powder. In particular, the 3D printer 100, 100A may form the 3D object 106 from the powder via the build platform 102 or similar component. In certain examples, the 3D printer 100A may form the 3D object 106 from powder via a build chamber 108 having the build platform 102. Indeed, the build platform 102 may be associated with a build chamber 108 of the 3D printer 100A. In some examples, the 3D printer 100A may employ its build chamber 108 and build platform 102 to print the 3D object 106 from powder fed to the build chamber 108.

The collection system 104 recovers spill-over or incidental powder 110 lost from the build platform 102 or similar structure of the 3D printer 100, 100A during printing of the 3D object 106. In certain examples, the collection system 104 may collect powder from the build chamber 108 to recover the incidental powder 110 lost from the build platform 102. Further, in the illustrated example, the collection system 104 may provide the recovered incidental powder 110 as recovered or reclaim powder 112 for printing during the same print job. In other words, the reclaim powder 112 may be fed to the build platform 102 or build chamber 108 during the current print job in which the incidental powder 110 spilled-over or was otherwise lost from the build platform 102.

In operation for the printing, the powder fed to the build platform 102 may include fresh or new powder 114 and recycle powder 116 at a specified weight ratio of new powder 114 to recycle powder 116. In addition, the powder fed to the build platform 102 may include the reclaim powder 112. In some examples, the reclaim powder 112 is fed in-line with the new powder 114 and the recycle powder 116 to the build platform 106 (e.g., fed to the build platform 106, fed to the build chamber 108 associated with the build platform 106, etc.). Moreover, the reclaim powder 112 may have the specified ratio of fresh or new powder to recycle powder, as the incidental powder 110 is recovered and returned as reclaim powder 112 during the current job of printing the 3D object 106.

The ratio of new powder to recycle powder can be a weight ratio, volume ratio, density ratio, and so forth. In one example, the ratio is a weight ratio in a range of 0 to 1 including any numerical value between 0 and 1, and in which at the ends of the range either 100% new powder or 100% recycle powder is fed, along with reclaim powder 112 having that composition. The ratio may be a weight ratio of new powder to recycle powder in a range of 0.01 to 0.99, 0.1 to 0.9, 0.2 to 0.9, 0.2 to 0.8, 0.3 to 0.8, and so forth. In some examples, the feed powder includes more recycle powder than new powder.

Moreover, as indicated for certain examples, the reclaim powder 112 is not classified as recycle powder but instead classified as powder having the specified ratio of new powder to recycle powder. This may provide economic benefit, such as in reducing the amount of new powder 114 fed for the print job. Moreover, in some examples, the recycle powder 116 may be powder that has been subjected to fusing energy or melting energy in the 3D printer 100, 100A without being fused and without, for example, having a melting or fusing agent printed thereon. Repeated exposure to melting energy or fusing energy can degrade the qualities of some powders. Hence, fresh or new powder 114 may be fed with the recycle powder 116. In examples, incidental powder 110 or reclaim powder 114 has not been generally subject to melting or fusing energy, and thus may have properties close or similar (if not the same) to fresh powder (or to at least a mix of fresh and recycled powder).

The collection system 104 may collect and recover the incidental powder 110 as reclaim powder 112 by vacuum, gravity, pneumatic conveying, or mechanical conveying, or any combination thereof. For instance, the collection system 104 may employ a vacuum system and a pneumatic conveying system to recover and provide or make available the incidental powder 110 as reclaim powder 112. In some examples, an intermediate storage vessel (not shown) may be employed to store the reclaim powder 112 prior to providing the reclaim powder 112 to the build platform 102 or to a feed system of the printer 100, 100A. Indeed, the collection system 104 may include a storage vessel (e.g., hopper, bin, etc.) to store the incidental powder 110 as reclaim powder 112. Additional equipment in the collection system 104 may include, for instance, screens, sieves, or shakers to remove relatively large particles or conglomerated powder from the incidental powder 110.

In certain examples, the collection system 104 includes a vacuum system to collect incidental powder 110 lost from the build platform 102. In a particular example, the collection system 104 includes a perimeter vacuum system to collect the incidental powder 110 from the build chamber 108 associated with the build platform 102. In sum, the collection system 104 may include or be associated with, for example, one or more pneumatic conveying systems or mechanical conveying systems, etc., to provide or forward the reclaim powder 112 to the build chamber 108 or build platform 102, or to a feed system of the 3D printer 100, 100A, and the like.

Thus, a mix of fresh or new powder and recycle powder may be utilized as feed powder to reduce costs. However, 100% fresh powder or new powder may be fed. On the other hand, 100% recycled powder may be fed, such as for printing for low-quality parts or for draft printing, and the like. For the feed powder being 100% new powder or 100% fresh powder, the incidental powder collected as reclaim powder would typically have that composition of 100% new powder or 100% fresh powder. In general, a single powder feed could be 100% fresh or new, or 100%, recycled, or a mix of the two, and plus the reclaim powder.

An example of a method of 3D printer includes feeding powder to a build platform of the 3D printer, collecting incidental powder lost from the build platform to give reclaim powder, feeding the reclaim powder to the build platform; and printing a 3D object from build material via the build platform, the build material comprising the powder and the reclaim powder. The collecting of incidental powder may employ a vacuum system and a pneumatic conveying system to reclaim incidental powder lost from the build platform to give the reclaim powder. The collecting of the incidental powder may involve employing a vacuum system to collect the incidental powder lost from the build platform, and storing the incidental powder as the reclaim powder in a vessel. In certain instances, the powder may include new powder and recycle powder at a specified ratio, wherein the reclaim powder has that specified ratio, and wherein the build material includes the new powder, the recycle powder, and the reclaim powder.

Another example. is a 3D printer including a build platform for the 3D printer to print a 3D object from build material including feed powder. The 3D printer includes a collection system to recover incidental powder lost from the build platform during printing of the 3D object. Further, the 3D printer includes a feed system to provide the feed powder to the build platform, wherein the feed system to return the incidental powder to the build platform. In some instances, the collection system may include a storage vessel to recover incidental powder lost from the build platform, a pneumatic conveying system to recover incidental powder lost from the build platform, and so on. Moreover, in some examples, the feed powder has a specified ratio of new powder to recycle powder. Further, the 3D printer may include a build chamber associated with the build platform. If so, the collection system may have a vacuum system to recover incidental powder lost from the build platform such as collecting the incidental powder from the build chamber via the vacuum system.

Yet another example is a 3D printer including a build platform for the 3D printer to print a 3D object from build material including feed powder. The 3D printer includes a collection system to recover incidental powder lost from the build platform during printing of the 3D object. The 3D printer includes a feed system to provide the feed powder to the build platform, wherein the feed system to return the incidental powder to the build platform. In addition, the collection system may include or share a vacuum system to recover incidental powder lost from the build platform. Further, on certain instances, the collection system may include a storage vessel to recover incidental powder lost from the build platform, a pneumatic conveying system to recover incidental powder lost from the build platform, and the like. Furthermore, the 3D printer may have a build chamber associated with the build platform. Moreover, in some instances, the feed powder may have a specified ratio of new powder to recycle powder. The collection system may recover the incidental powder as reclaim powder having the specified ratio. The feed system may combine the new powder, the recycle powder, and the reclaim powder to give the feed powder.

Lastly, the terms “new” powder and “fresh” powder may be synonyms in the above context. Moreover, new powder can be fresh powder, powder not yet used, and the like.

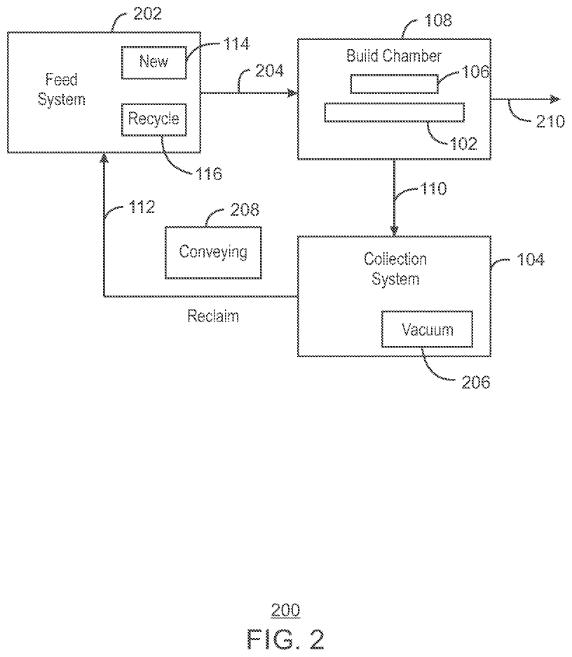

FIG. 2 is a 3D printer 200 which may be employed in AM to print a 3D object 106. The 3D printer 200 may have a build surface or build platform 102 to form the 3D object 106. In the illustrated example, the printer 200 includes a build enclosure at least partially enclosing the build platform 102, and which may be labeled as a build chamber 108. Further, in particular examples, the build platform 102 may be associated with a build bucket, and in which the build platform resides on a movement device (e.g., a piston) that is incrementally lowered as the 3D object is formed layer-by-layer.

The printer 200 includes a feed system 202 and a collection system 104. The feed system 202 provides feed powder 204 for the build chamber 108 and build platform 102 in the printing of a 3D object 106 by the 3D printer 200. The collection system 104 recovers spill-over or incidental powder 110 lost from the build platform 102 or similar component of the 3D printer 200 during printing of the 3D object 106. As discussed, the collection system 104 may collect and recover the incidental powder 110 as recovered powder or reclaim powder 112 by vacuum, gravity, pneumatic conveying, or mechanical conveying, and the like. For instance, the collection system 104 may employ a vacuum system 206 (e.g., a perimeter vacuum system) on the build chamber 108 to collect the incidental powder spill-over from the build platform 102. However, the collection system 104 may employ systems (e.g., gravity, pneumatic or mechanical conveying, etc.) other than the depicted vacuum system 206 to collect the incidental powder 110 from the build chamber 108 or from the build platform 102. Indeed, the collection system 104 may employ systems in addition to or in lieu of a vacuum system 206 to recover incidental powder 110.

The 3D printer 200 may include one or more conveying systems 208 (e.g., pneumatic conveying, mechanical conveying, vacuum-driven conveying, or a combination thereof, etc.) to provide for or transport the incidental powder 110 as reclaim powder 112 to the feed system 202. Such a conveying system 208 may be a component of the collection system 104 or shared by the collection system 104 with, for example, the feed system 202 or other systems. Furthermore, in certain examples, the conveying system 208 may participate in the collection of the incidental powder 110 from the build chamber 108, depending on the specific printer 200 or application.

Moreover, in some examples, the reclaim powder 112 may be provided from the collection system 104 directly as a contribution of the powder 204. In particular examples, the reclaim powder 112 may be mixed in-line with new powder 114 and recycle powder to give the feed powder 204 to the build chamber 108. In general, the collection system 104 (and feed system 202) provides for the recovered incidental powder 110 as reclaim powder 112 for printing during the same (current) print job in which the incidental powder 110 was lost.

In the collection system 104, an intermediate storage vessel may also be employed to store the reclaim powder 112 prior to providing the reclaim powder 112 to the feed system 202. Furthermore, the reclaim powder may be routed through the feed system 202 as depicted and/or directly as an in-line contribution to the powder 204. As mentioned, the collection system 104 may further include a large-particle remover (e.g., vessels, screens, sieves, shakers, etc.) to remove relatively large particles or conglomerated powder from the incidental powder 110.

The printer 200 may form the 3D object 106 via the build platform 102 from build material including the feed powder 204, For example, in operation, a build bed of material (including the powder 204) may be disposed on the build platform 102 and in which the powder 204 is fused layer-by-layer to form the 3D object 106. The powder 204 may be metal, plastic, concrete, composite material, or other powders. After completion of the print job, the 3D object 106 may be removed from the 3D printer 200, as noted by arrow 210. The product 210 may be a finished product or subjected to additional downstream processing such as post-processing, finishing, and so forth.

To generate the 3D object 106, the 3D printer 200 may form via the build platform 102 successive layers with the build material (including powder 204 and with portions of the powder 104 as melted, fused, solidified, etc.) under computer control to fabricate the 3D object 106. As defined herein, build material may include powder(s) and powder-like materials. The 3D objects 106 so formed can be various shapes and geometries, and produced via a model such as a 3D model or other electronic data source. This fabrication by the 3D printer 200 may involve laser melting, laser sintering, electron beam melting, fused deposition or fusion, and so on. The model and automated control may facilitate the layered manufacturing and additive fabrication. As for applications, the 3D printer 200 may fabricate objects 106 as prototypes or products 210 for aerospace (e.g., aircraft), machine parts, medical devices (e.g., implants), automobile parts, fashion products, structural and conductive metals, ceramics, conductive adhesives, semiconductor devices, and other applications.

In the illustrated example, the build chamber 108 and build platform 102 receives material such as powder 204 from the feed system 202 for the printer 200 to form the 3D object 106. The powder 204 may include new or fresh powder 114 and recycle powder 116 at a specified ratio (e.g., weight ratio) of the new powder 114 to the recycle powder 116. Recycle powder 116 may be powder recovered from the 3D printer 102 or other printers from previous builds or print jobs, and other captured powders. For instance, powder-bed support material in the printer 102 that is not fused into parts or objects 106 may be collected as recycled powder 116.

In some examples, the feed system 202 may include respective vessels (e.g., hoppers, bins, cartridges, cyclones, cartridges, etc.) to store the new powder 114 and recycle powder 116, for feeding the respective powder to the build chamber 108 and build platform 102. Further, the feed system 202 may include a vessel to store the reclaim powder 112.

In addition, the feed system 202 may include a feed or dispense vessel (e.g., hopper, bin, etc.) near the build chamber 108 to store and feed a combination of the new powder 114 and recycle powder 116. If so, the dispense vessel may also receive, store, and feed the reclaim powder 112 along with the new powder 114 and recycle powder 116 to the build chamber 108 or build platform 102. A dispense vessel may store and feed a combination of the new powder 114, recycle powder 116, and reclaim powder 112.

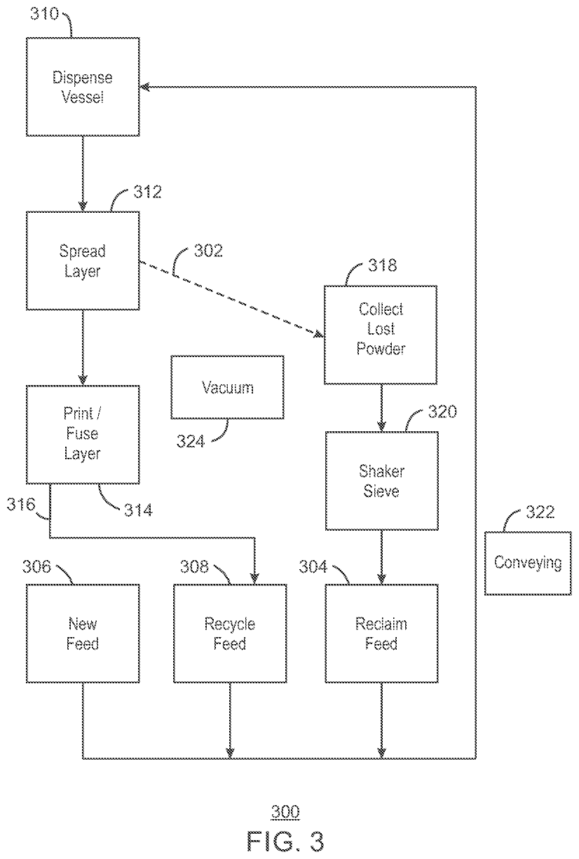

FIG. 3 is a 3D printer 300 that collects incidental powder 302 such as powder spill-over from a build surface or build platform of the 3D printer 300. The printer 300 may re-use the incidental powder 302 in the same or current print job in which the incidental powder 302 was collected. The incidental powder 302 may be recovered as recovered powder or reclaim powder that is fed back for printing.

Thus, the printer 300 includes recovered or reclaim powder feed 304, fresh or new powder feed 306, and recycle powder feed 308. In the illustrated example, the printer 300 includes a dispense vessel 310 to receive a combination of these powders. The combination may include a specified weight ratio (e.g., in a range of 0.2 to 0.8) of new powder to recycle powder. For instance, the 3D printer 300 may meter the new feed 308 and the recycle feed 308 at the specified ratio. In some examples, the reclaim powder feed 304 supplied may already have the specified ratio because the incidental powder 302 may be collected during the current or similar print job.

The dispense vessel 310 may provide or make available the combination of powder (e.g., as feed powder) to a spread layer 312 across a build platform of the 3D printer 300. The 3D printer 300 in printing a 3D object may fuse powder layer-by layer, as indicated by reference numeral 314. At the conclusion of the print job (e.g., and including in post-processing if implemented), excess or unused powder may be captured 316 for use as recycle powder. Furthermore, incidental powder 302, such as powder spill-over or powder otherwise lost from the build platform including during spreading of powder during the print job, may be collected as reclaim powder, as noted by reference numeral 318. The incidental powder 302 may be subjected to a treatment system 320 (e.g., a shaker sieve) to remove large or conglomerated powder particles. In the illustrated example, the incidental powder 302 minus the larger particles removed by the treatment system 320 may be collected and recovered as reclaim powder feed 304.

The 3D printer 300 may include a conveying system 322 to facilitate supply of the reclaim powder feed 304, new powder feed 306, and recycle powder feed 308 to the dispense vessel 310. The conveying system 322 may be for example, a pneumatic conveyance system or a mechanical conveyance system. The printer 300 may also include a vacuum system 324 to facilitate recovery of the incidental powder 302 lost from the spread layers. In a particular example, the vacuum system 324 is a perimeter vacuum system around a build chamber of the printer 300,

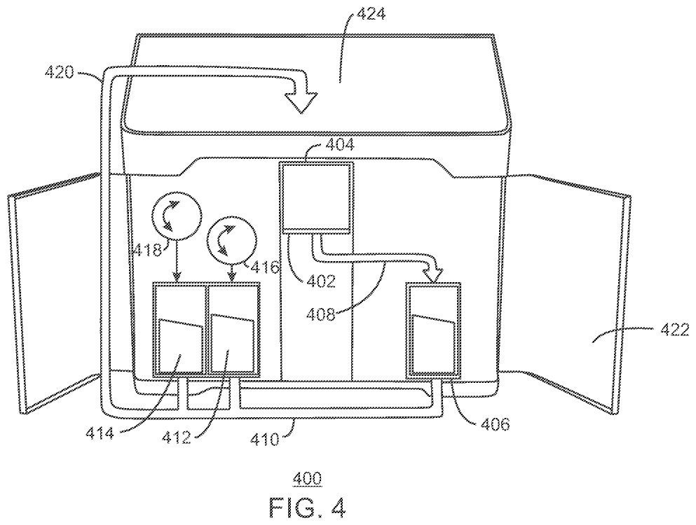

FIG. 4 is a 3D printer 400 having a build platform 402 and a build enclosure 404. The printer 400 includes a reclaim powder vessel 406 to receive incidental powder 408 as recovered powder or reclaim powder 410. The incidental powder 408 may be powder lost from the build platform 402 during printing of a 3D object on the build platform 402.

The 3D printer 400 includes a recycle powder vessel 414 (e.g., hopper, bin, etc.) and a new powder vessel 412 that may provide for recycle powder and new powder, respectively. The new powder, recycle powder, and reclaim powder 410 may be combined and transported as feed powder 420 to the build enclosure 404 and build platform 402. In some examples, printer 400 components such as a conveying system, a feed vessel or dispense vessel, a spreading arm, a solidification system, and so on, may facilitate supply of the feed powder 420 to the build enclosure 404 (e.g., build chamber, build bucket, etc.) and the build platform 402.

Moreover, the recycle powder discharging from the recycle powder vessel 412 and the new powder discharging from the new powder vessel 414 may be controlled or metered such that a desired ratio of new powder to recycle powder is provided or made available. The reclaim powder 410 may have the desired ratio when the reclaim powder 410 is the incidental powder 408 collected during the current or similar print job.

In the illustrated example, the printer 400 includes a recycle cartridge receiver 416 to hold a recycle powder cartridge, and a new cartridge receiver 418 to hold a new powder cartridge. A recycle powder cartridge may discharge recycle powder to the recycle powder vessel 412. A new powder cartridge may discharge new powder to the new powder vessel 414. The new cartridge receiver 418 and the recycle cartridge receiver 416 may each be a receptacle, cavity, sleeve, slot, and the like. Moreover, in some examples, the recycle powder cartridge in the recycle cartridge receiver 416 may accept excess or unused powder from the build enclosure 404. Likewise, the recycle powder vessel 412 may receive unused or excess powder from the build enclosure 404.

In this example, the 3D printer 400 has doors 422 and a top surface 424. The printer 400 may generally have a partial or overall enclosure to house printer 400 components. Some printer components may be readily removable oe operationally removable, whereas other components may be more static or intended to not be regularly removed. Lastly, the arrows denoted by reference numerals 408, 410, and 420 are representations of general flow of powder. The printer conduits (e.g., piping, tubing, etc.) associated with such flow of powder may be house inside the printer 400 in some examples.

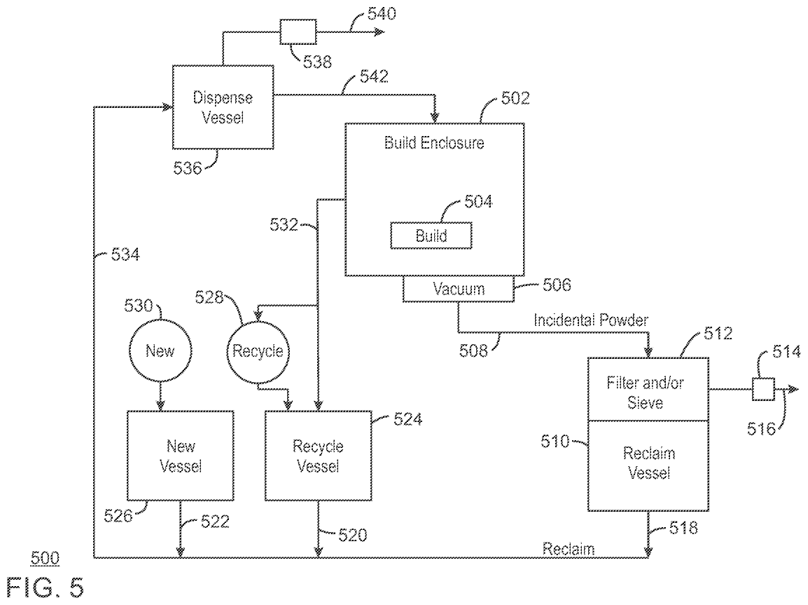

FIG. 5 is a 3D printer 500 including a build enclosure 503 (e.g., build chamber, build bucket, etc.) and a build platform 504. A vacuum system 506 (e.g., a perimeter vacuum system) facilitates collection of incidental powder 508 from the build enclosure 502 during the printing of a 3D object on the build platform 504. The incidental powder 508 may be powder lost from the build platform 504, such as powder spill-over from the build platform 504 during the printing of the 3D object. The incidental powder 508 collected, such as via the vacuum system 506, may be stored in a recovered powder or reclaim powder vessel 510.

The incidental powder 508 and vacuum gas (e.g., air) in route to the reclaim powder vessel 510 may be subjected to or processed in a treatment system 512. The treatment system 512 may include, for example, a sieve to remove large or conglomerated powder particles. The treatment system 512 may include, for example, a filter or cyclone, to separate the conveying vacuum air from the incidental powder 508. The vacuum air may discharge through one or more vacuum components 514, as indicated by reference number 516. The vacuum component(s) 514 (e.g., venturi, blower, vacuum pump, etc.) may provide for vacuum suction of the vacuum system 506.

The reclaim powder vessel 510 may make available the reclaim powder 518 for transport the build platform 504 in the printing of the 3D object. Moreover, the reclaim powder 518 may be combined with recycle powder 520 and fresh or new powder 522. The printer 500 may include a recycle powder vessel 524 and a new powder vessel 526 to provide the recycle powder 520 and new powder 522, respectively. In some examples, the recycle powder 520 and the new powder 522 may be provided to give a desired or specified ratio (e.g., weight ratio or volume ratio) of new powder 522 to recycle powder 520. The reclaim powder 518 may have the desired or specified ratio of new powder to recycle powder.

Further, in some examples, the printer 500 may include a recycle cartridge receiver 528 to hold a recycle powder cartridge to supply recycle powder to the recycle powder vessel 524. The printer 500 may also include a new cartridge receiver 530 to hold a new powder cartridge to supply new powder to the new powder vessel 526. In certain examples, the powder cartridges may have an enclosure (e.g., container, housing, etc.) to hold and store powder for supply. Moreover, in particular examples, the recycle powder vessel 524 and/or recycle powder cartridge may receive unused or excess powder 532 from the build enclosure 502. If so, this unused or excess powder 532 may be classified as recycle powder or other powder.

In the illustrated example, the reclaim powder 518, recycle powder 524, and new powder 522 may be fed as feed powder 534 to a dispense vessel 536. The printer 500 may include a conveying system to facilitate transport of the feed powder 534 to the dispense vessel 536 and to the build enclosure 502. In some examples, a pneumatic conveying system is employed. If so, the pneumatic conveying system may include a vacuum component 538 which may be a venturi, blower, or both, etc. The pneumatic conveying air 540 may discharge through the vacuum component(s) 538. The feed powder 534 minus most or all of the conveying air may flow (e.g., by gravity, air flow, etc.) from the dispense vessel 536, as indicated by reference numeral 542, to the build enclosure 502 or other printer components for printing of a 3D object on the build platform 504.

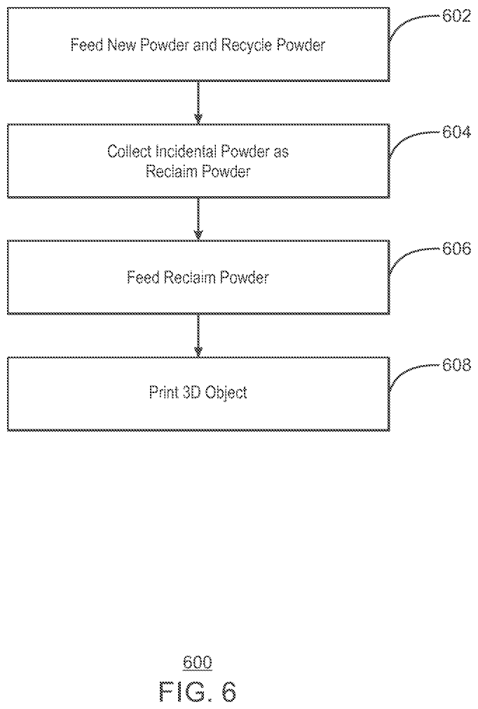

FIG. 6 is a method 600 of operating a 3D printer. At block 602, the method includes feeding new powder and recycle powder at a specified ratio (e.g., weight ratio, volume ratio, etc.) to a build platform of the 3D printer. In some examples, the powder may be fed to a build chamber associated with the build platform. In certain examples, the specified ratio is a weight ratio of new powder to recycle powder in a range of 0.2 to 0.8. Further, the feeding of the new powder and the recycle powder at the specified ratio may include combining the new powder with the recycle powder upstream of the build platform. In examples, the recycle powder may include powder recovered from the 3D printer and associated with a previous print job.

At block 604, the method includes collecting incidental powder lost from the build platform to give reclaim powder having the specified ratio. The incidental powder may include spill-over powder from the build platform during the printing of the 3D object. Further, the collecting of incidental powder lost from the build platform may involve collecting the incidental powder as reclaim powder separate from collection handling of recycle powder and without classifying the incidental powder as recycle powder.

The action of not classifying the recovered incidental powder as recycle powder but instead as powder have the desired ratio of new powder to recycle powder may provide economic benefit, for example, in reducing the amount of new powder fed to the build platform. Moreover, the incidental powder (e.g., spill-over powder) may be collected (e.g., during the current print job) separate from the unused or excess powder collected (e.g., at completion of print job) as recycle powder. Furthermore, as mentioned, the recycle powder may be powder that has been subjected to fusing energy or melting energy in the 3D printer without being fused and without, for example, having a melting or fusing agent printed thereon. In examples, the incidental powder has not been generally subject to melting or fusing energy.

The collecting of the incidental powder may include collecting the incidental powder by vacuum, gravity, pneumatic conveying, or mechanical conveying, or any combinations thereof. In a particular example, the collection of incidental powder includes employing a vacuum system to collect incidental powder lost from the build platform, and storing the incidental powder as reclaim powder in a vessel. In certain examples, a vacuum system and a pneumatic conveying system are employed to reclaim incidental powder lost from the build platform to give the reclaim powder. Moreover, for a build platform associated with a build chamber, the incidental powder lost from the build platform may be collected from the build chamber.

At block 606, the method includes feeding the reclaim powder (e.g., collected incidental powder) to the build platform. In some examples, feeding the reclaim powder includes feeding the reclaim powder in-line with the new powder and the recycle powder to a build chamber associated with the build platform. Such may involve meeting conduits to give a single conduit providing a mix of the new powder, recycle powder, and reclaim powder. Moreover, such may involve mixing via the meeting of the conduits (e.g., via conduit tees or other fittings) of the powders or more active mixing (e.g., via an in-line static mixer) of the powders. At block 608, the method includes printing a 3D object from material via the build platform, the material including the new powder, the recycle powder, and the reclaim powder.

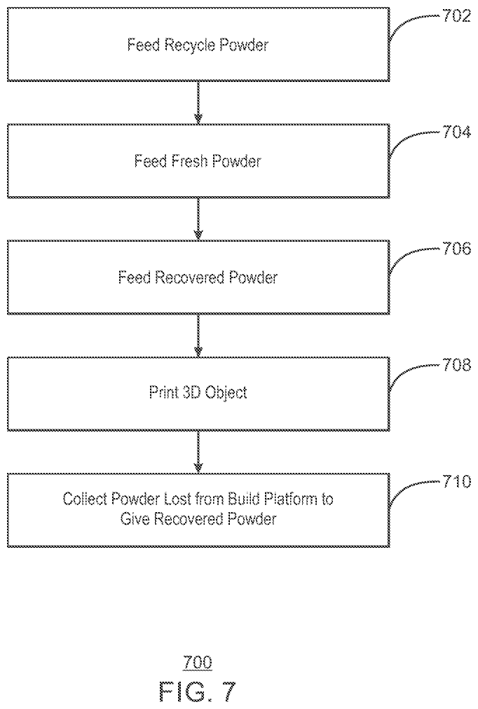

FIG. 7 is a method 700 of operating a 3D printer. At block 702, the method includes feeding recycle powder to a build chamber of the 3D printer. At block 704, the method includes feeding new or fresh powder to the build chamber at a specified weight ratio to the recycle powder. At block 706, the method includes feeding reclaim or recovered powder to the build chamber, At block 708, the method includes printing, via a build platform of the 3D printer, a 3D object from build material including a combined feed having the recycle powder, the fresh powder, and the recovered powder. The build chamber may be associated with the build platform.

At block 710, the method includes collecting powder lost from the build platform during the printing of the 3D object to give the reclaim powder or recovered powder. The recovered powder may have the specified weight ratio of fresh powder to recycle powder. In one example, the collecting of powder lost from the build platform includes employing a perimeter vacuum system on the build chamber.

In certain examples, the collecting of powder lost from the build platform may involve employing printer components such as a vacuum system or a pneumatic conveying system, or both. In general, the collecting of incidental powder lost from the build platform may include collecting the incidental powder by vacuum, gravity, pneumatic conveying, or mechanical conveying, or any combinations thereof.

In summary, an example is a 3D printer that has a feed system to provide feed powder having a specified ratio (e.g., weight ratio or volume ratio) of new powder to recycle powder to a build platform. The feed powder further includes reclaim powder having the specified ratio. The 3D printer includes the build platform for the 3D printer to print a 3D object from the feed powder. In certain examples, the 3D printer may include a build chamber associated with the build platform.

In addition, the printer has a collection system to recover incidental powder lost from the build platform during printing of the 3D object. The incidental powder may be recovered as the reclaim powder and having the specified ratio. In some examples, the collection system may include a vacuum system or a pneumatic conveying system, or both, to recover incidental powder lost from the build platform. Further, the collection system may include a storage vessel to recover and store incidental powder lost from the build platform.

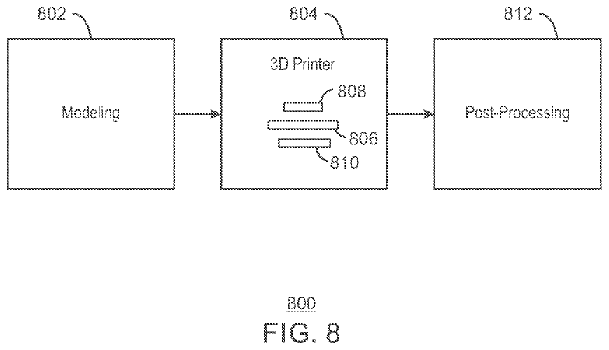

FIG. 8 is an AM system 800 which includes a modeling system 802 and a 3D printer 802. The 3D printer 802 may be analogous to one or more of the respective 3D printers depicted in the preceding figures. The AM system 800 may involve 3D printing performed by the 3D printer 802 as a materials printer using digital technology. In certain examples, the AM including 3D printing may form 3D solid objects from a digital model. Indeed, the AM system 800 may include the modeling system 802 to receive a model, prepare a received model, or generate a model, and the like, for AM and 3D printing. The model may be a 3D model. Moreover, the model may be “sliced” in preparation for the layer-by-layer printing. Digital data may be obtained from electronic data sources other than a model.

The model or other electronic source may provide digital 3D design data for the AM 3D printer 802 to build a component or product in layers by depositing material and including fusion, sintering, melting, deposition, solidification, etc., of portions of the material. Such AM may be in contrast to milling a workpiece from solid block, for example. The AM 3D printer relying on the model may build the product layer-by-layer employing materials, for example; in powder form. A range of different metals, plastics, and composite materials may be used. Unlike subtractive manufacturing techniques that start with a solid block of material and then cut away the excess to create a finished part, AM may build a part (or features onto parts) layer-by-layer from geometry described in a 3D design model. Of course, subtractive manufacturing (e.g., subtractive machining) may be employed in conjunction with AM in certain examples.

The AM system 800 includes one or more printers 704 to print (fabricate) the 3D solid object. The solid object may be a product which may be a full product; a part of a product, a prototype, and so on. Again, 3D printing or AM may make 3D solid objects from a digital file. An object may be created by laying down successive layers of material until the object is created. In some instances; each of these layers can be seen as a thinly sliced horizontal cross-section of the eventual object. The 3D printing may involve sintering, melting, fusing, or fusion of the material or powder by energy sources such as a laser, electron beam, light, ultraviolet light, heat; and so forth. The 3D printing may involve other AM printing techniques.

In the illustrated example, the 3D printer 804 includes a build surface or build platform 806 on which the 3D object 808 is printed and formed from material including powder. New powder and recycle powder may be fed to the build platform 806 for fabrication of the 3D object 808. Further, the 3D printer 804 includes a collection system 810 to recover incidental powder lost from the build platform 806 during the printing of the 3D object 808. The collection system 810 may include a vacuum system, storage vessel(s), conveying system(s) such as mechanical conveying or pneumatic conveying, and so forth. The incidental powder may be collected via the collection system 810 as reclaim powder and fed back to the build platform 806 during the printing of the 3D object 808. The reclaim powder may be fed with the new powder and the recycle powder.

The AM system 800 may include a post-processing system 812 to perform finishing or other processing of the 3D object 808. The post-processing system 812 may involve support removal, powder removal, sanding, vapor smoothing, painting, electroplating, metal-machining, polishing, and the like.

While the present techniques may be susceptible to various new modifications and alternative forms, the examples discussed above have been shown by way of example. It is to be understood that the technique is not intended to be limited to the particular examples disclosed herein. Indeed, the present techniques include alternatives, modifications, and equivalents falling within the true spirit and scope of the appended claims.

What is claimed is:

1. A method of operating a three-dimensional (3D) printer, comprising:
feeding powder to a build platform of the 3D printer;
collecting incidental powder lost from the build platform to give reclaim powder;
feeding the reclaim powder to the build platform; and
printing a 3D object from build material via the build platform, the build material comprising the powder and the reclaim powder.

2. The method of claim 1, wherein collecting incidental powder comprises employing a vacuum system and a pneumatic conveying system to reclaim incidental powder lost from the build platform to give the reclaim powder.

3. The method of claim 1, wherein collecting incidental powder comprises:
employing a vacuum system to collect the incidental powder lost from the build platform; and
storing the incidental powder as the reclaim powder in a vessel.

4. The method of claim 1, wherein the powder comprises new powder and recycle powder at a specified ratio, wherein the reclaim powder comprises the specified ratio, and wherein the build material comprises the new powder, the recycle powder, and the reclaim powder.

5. The method of claim 4, wherein collecting incidental powder lost from the build platform comprises collecting the incidental powder as reclaim powder without classifying the incidental powder as recycle powder but instead classifying the powder as the reclaim powder having the specified ratio, and wherein feeding the reclaim powder comprises feeding the reclaim powder in-line with the new powder and the recycle powder to a build chamber associated with the build platform.

6. The method of claim 4, wherein the specified ratio comprises a weight ratio of new powder to recycle powder in a range of 0.2 to 0.8, and wherein collecting incidental powder comprising collecting incidental powder by vacuum, gravity, pneumatic conveying, or mechanical conveying, or any combinations thereof.

7. The method of claim 4, wherein feeding the new powder and the recycle powder to the build platform comprises feeding the new powder and the recycle powder at the specified ratio to a build chamber of the 3D printer, the build chamber comprising the build platform, and wherein collecting incidental powder lost from the build platform comprises collecting the incidental powder from the build chamber.

8. The method of claim 5, wherein feeding the new powder and the recycle powder at the specified ratio comprises combining the new powder with the recycle powder upstream of the build platform; wherein the recycle powder comprises powder recovered from the 3D printer and associated with a previous print job; and wherein the incidental powder comprises spill-over powder from the build platform during the printing of the 3D object.

9. A method of operating a three-dimensional (3D) printer, comprising:
feeding recycle powder to a build chamber of the 3D printer;
feeding fresh powder to the build chamber at a specified weight ratio to the recycle powder;
feeding recovered powder to the build chamber;
printing, via a build platform of the 3D printer, a 3D object from a combined feed having the recycle powder, the fresh powder, and the recovered powder;
collecting powder lost from the build platform by vacuum, gravity, pneumatic conveying, or mechanical conveying, or any combinations thereof, during the printing of the 3D object to give the recovered powder.

10. The method of claim 9, wherein collecting powder lost from the build platform comprises employing a perimeter vacuum system on the build chamber, and wherein the recovered powder has the specified weight ratio of fresh powder to recycle powder.

11. The method of claim 9, wherein the build chamber is associated with the build platform, and wherein collecting powder lost from the build platform comprises employing a vacuum system and a pneumatic conveying system.

12. A three-dimensional (3D) printer comprising:
a build platform for the 3D printer to print a 3D object from build material comprising feed powder;
a collection system to recover incidental powder lost from the build platform during printing of the 3D object;
a feed system to provide the feed powder to the build platform, wherein the feed system to return the incidental powder to the build platform.

13. The 3D printer system of claim 12, wherein the collection system comprises:
a storage vessel to recover incidental powder lost from the build platform; and
a pneumatic conveying system to recover incidental powder lost from the build platform.

14. The 3D printer system of claim 12, wherein the feed powder comprises a specified ratio of new powder to recycle powder, wherein the 3D printer comprises a build chamber associated with the build platform, and wherein the collection system comprises a vacuum system to recover incidental powder lost from the build platform.

15. The 3D printer system of claim 14, wherein the collection system to recover the incidental powder as reclaim powder comprising the specified ratio, and wherein the feed system to combine the new powder, the recycle powder, and the reclaim powder to give the feed powder.
